(19) United States
(12) Patent Application Publication
(10) Pub. No.: US 2021/0231908 A1
(43) Pub. Date: Jul. 29, 2021

(54) CONTROL DEVICE, CAMERA DEVICE, CONTROL METHOD, AND PROGRAM

(71) Applicant: VICTOR HASSELBLAD AB, GÖTENBORG (SE)

(72) Inventors: Takashi KOYAMA, Tokyo (JP); Kenichi HONJO, Tokyo (JP); Kenji MATSUMOTO, Tokyo (JP)

(21) Appl. No.: 17/233,430

(22) Filed: Apr. 16, 2021

Related U.S. Application Data
(63) Continuation of application No. PCT/CN2019/114020, filed on Oct. 29, 2019.

(30) Foreign Application Priority Data
Oct. 29, 2018 (JP) 2018-202708

(51) Int. Cl. G02B 7/09; G03B 13/34

(52) U.S. Cl. CPC G02B 7/09; G03B 2205/0046; G03B 13/34

(57) ABSTRACT

A control device includes a processor and a storage device. The storage device stores a program that, when executed by the processor, causes the processor to perform speed control to perform speed control to cause a speed of a lens of a camera device to reach a target speed, during the speed control, obtain a current value of a current provided to an electric motor of the camera device configured to drive the lens, determine a stop moment of stopping providing the current to the electric motor according to the current value, and control to stop providing the current to the electric motor at the stop moment to cause the lens to stop at a stop position.

### CROSS-REFERENCE TO RELATED APPLICATIONS

This application is a continuation of International Application No. PCT/CN2019/114020, filed Oct. 29, 2019, which claims priority to Japanese Application No. 2018-202708, filed Oct. 29, 2018, the entire contents of both of which are incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to a control device, a camera device, a control method, and a program.

### BACKGROUND

Japanese Patent Application Laid-Open No. 10-164417 discloses controlling a speed of a focus lens to cause the focus lens to stop at a target position.

### SUMMARY

Embodiments of the present disclosure provide a control device including a processor and a storage device. The storage device stores a program that, when executed by the processor, causes the processor to perform speed control to cause a speed of a lens of a camera device to reach a target speed, during the speed control, obtain a current value of a current provided to an electric motor of the camera device configured to drive the lens, determine a stop moment of stopping providing the current to the electric motor according to the current value, and control to stop providing the current to the electric motor at the stop moment to cause the lens to stop at a stop position.

Embodiments of the present disclosure provide a camera device including a lens, an electric motor, an image sensor, and a control device. The control device includes a processor and a storage device. The electric motor is configured to drive the lens. The storage device stores a program that, when executed by the processor, causes the processor to perform speed control to cause a speed of the lens of the camera device to reach a target speed, during the speed control, obtain a current value of a current provided to an electric motor of the camera device configured to drive the lens, determine a stop moment of stopping providing the current to the electric motor according to the current value, and control to stop providing the current to the electric motor at the stop moment to cause the lens to stop at a stop position.

Embodiments of the present disclosure provide a control method. The method includes performing speed control to cause a speed of a lens of a camera device to reach a target speed, during the speed control, obtaining a current value of a current provided to an electric motor of the camera device configured to drive the lens, determining a stop moment of stopping providing the current to the electric motor according to the current value, and controlling to stop providing the current to the electric motor at the stop moment to cause the lens to stop at a stop position.

### BRIEF DESCRIPTION OF THE DRAWINGS

FIG. 1 is a schematic perspective diagram showing an appearance of a camera device according to some embodiments of the present disclosure.

FIG. 2 is a schematic diagram showing functional modules of the camera device according to some embodiments of the present disclosure.

FIG. 3 is a schematic block diagram showing using a speed controller to execute a PID control according to some embodiments of the present disclosure.

FIG. 4A is a schematic diagram showing changes over time in a speed of a focus lens and a current value provided to an electric motor according to some embodiments of the present disclosure.

FIG. 4B is a schematic diagram showing changes over time in a speed of a focus lens and a current value provided to an electric motor according to some embodiments of the present disclosure.

FIG. 5 is a schematic diagram showing information indicating a correspondence between a difference (A) between a reference current value and a threshold and a time difference (μs), the time difference being a time difference to a reference time when the current stops, according to some embodiments of the present disclosure.

FIG. 6 is a schematic flowchart showing controlling a focus lens to move according to some embodiments of the present disclosure.

FIG. 7 is a schematic diagram showing an appearance of an unmanned aerial vehicle and a remote operation device according to some embodiments of the present disclosure.

FIG. 8 is a schematic diagram of a hardware configuration according to some embodiments of the present disclosure.

### REFERENCE NUMERALS

10 UAV
20 UAV body
50 Gimbal
60 Camera Device
100 Camera Device
102 Imaging unit
110 Camera controller
112 Focus controller
120 Image sensor
130 Storage device
160 Display
162 Indication unit
200 Lens unit
210 Focus lens
211 Zoom lens
212, 213 Lens driver
216, 217 Electric motor
218, 219 Encoder
220 Lens controller
222 Storage device
224 Acquisition unit
226 Determination unit
230 Speed controller
300 Remote operation device
1200 Computer
1210 Host controller
1212 Central processing unit (CPU)
1214 Random-access memory (RAM)
1220 I/O controller
1222 Communication interface
1230 Read-only memory (ROM)

### DETAILED DESCRIPTION OF THE EMBODIMENTS

The present disclosure is described through embodiments, but following embodiments do not limit the present disclosure. Not all the feature combinations described in embodiments of the present disclosure are necessary for the solutions of the present disclosure. Those of ordinary skill in the art can make various modifications or improvements to following embodiments. Such modifications or improvements are within the scope of the present disclosure.

Various embodiments of the present disclosure are described with reference to flowcharts or block diagrams. In this disclosure, a block in the figures can represent (1) an execution stage of a process of operation or (2) a functional unit of a device for operation execution. The referred stage or unit can be implemented by a programmable circuit and/or a processor. A special-purpose circuit may include a digital and/or analog hardware circuit or may include an integrated circuit (IC) and/or a discrete circuit. The programmable circuit may include a reconfigurable hardware circuit. The reconfigurable hardware circuit may include logical AND, logical OR, logical XOR, logical NAND, logical NOR, other logical operation circuits, a trigger, a register, a field-programmable gate arrays (FPGA), a programmable logic array (PLA), or another storage device.

A computer-readable medium may include any tangible device that can store commands executable by an appropriate device. The commands, stored in the computer-readable medium, can be executed to perform operations consistent with the disclosure, such as those specified according to the flowchart or the block diagram described below. The computer-readable medium may include an electronic storage medium, a magnetic storage medium, an optical storage medium, an electromagnetic storage medium, a semiconductor storage medium, etc. The computer-readable medium may include a floppy Disk®, hard drive, random access memory (RAM), read-only memory (ROM), erasable programmable read-only memory (EPROM or flash memory), electrically erasable programmable read-only memory (EEPROM), static random access memory (SRAM), compact disc read-only memory (CD-ROM), digital versatile disc (DVD), Blu-ray® disc, memory stick, integrated circuit card, etc.

A computer-readable command may include any one of source code or object code described by any combination of one or more programming languages. The source or object codes include traditional procedural programming languages. The traditional procedural programming languages can be assembly commands, instruction set architecture (ISA) commands, machine commands, machine-related commands, microcode, firmware commands, status setting data, or object-oriented programming languages and “C” programming languages or similar programming languages such as Smalltalk, JAVA (registered trademark), C++, etc. Computer-readable commands can be provided locally or via a wide area network (WAN) such as a local area network (LAN) or the Internet to a general-purpose computer, a special-purpose computer, or a processor or programmable circuit of other programmable data processing device. The processor or the programmable circuit can execute computer-readable commands to be a manner for performing the operations specified in the flowchart or block diagram. The example of the processor includes a computer processor, a processing unit, a microprocessor, a digital signal processor, a controller, a microcontroller, etc.

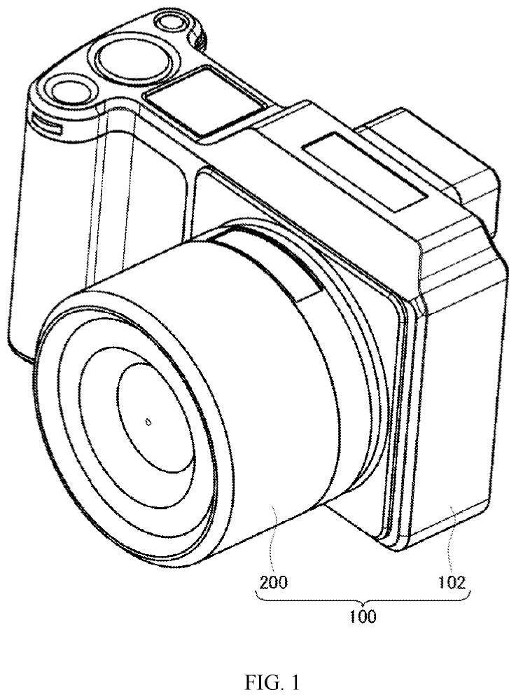

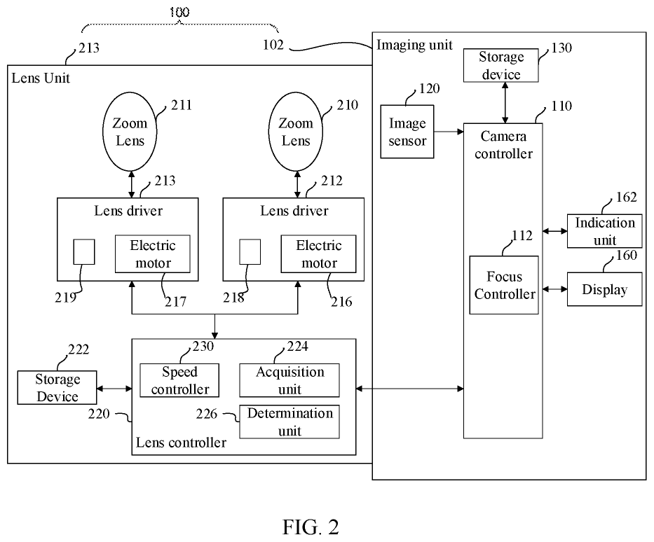

FIG. 1 is a schematic diagram showing an appearance of a camera device 100 according to some embodiments of the present disclosure. FIG. 2 is a schematic diagram showing functional modules of the camera device 100 according to some embodiments of the present disclosure.

The camera device 100 includes an imaging unit 102 and a lens unit 200. The imaging unit 102 includes an image sensor 120, a camera controller 110, and a storage device 130. The image sensor 120 may be composed of a charge coupled device (CCD) or a complementary metal oxide semiconductor (CMOS). The image sensor 120 captures an optical image imaged through a zoom lens 211 and a focus lens 210, and outputs image data of the captured optical image to the camera controller 110. The camera controller 110 may be composed of a microprocessor such as a central processing unit (CPU), a micro processing unit (MPU), etc., or a microcontroller such as a microcontroller unit (MCU). The storage device 130 may be a computer-readable storage medium and may include at least one of SRAM, DRAM, EPROM, EEPROM, or a USB flash drive. The storage device 130 stores programs required for the camera controller 110 to control the image sensor 120. The storage device 130 may be arranged inside a housing of the camera device 100. The storage device 130 may be detachably arranged at the housing of the camera device 100.

The imaging unit 102 further includes an indication unit 162 and a display 160. The indication unit 162 includes a user interface which is configured to receive an instruction for the camera device 100 from a user. The display 160 may display the image captured by the image sensor 120 and setting information of the camera device 100. The display 160 can include a touchpad.

The lens unit 200 includes the focus lens 210, the zoom lens 211, a lens driver 212, a lens driver 213, and a lens controller 220. The focus lens 210 and the zoom lens 211 may include at least one lens. The focus lens 210 and the zoom lens 211 may be at least partially or fully configured to move along an optical axis. The lens unit 200 may be an interchangeable lens arranged to be detachable from the imaging unit 102. The lens driver 212 includes an electric motor 216 and an encoder 218. The electric motor 216 may include a direct-current (DC) motor, an ironless motor, or an ultrasonic motor. The encoder 218 may be configured to detect a rotation speed of the electric motor 216. The lens driver 212 may be configured to transfer power of the electric motor 216 to at least some of or all of the focus lens 210 through a mechanism member such as a cam ring, a guide shaft, etc., to cause at least some of or all of the focus lens 210 to move along the optical axis. The lens driver 213 includes an electric motor 217 and an encoder 219. The electric motor 217 may include a DC motor, an ironless motor, or an ultrasonic motor. The encoder 219 may be configured to detect a rotation speed of the electric motor 217. The lens driver 213 may be configured to transfer power of the electric motor 217 to at least some of or all of the zoom lens 211 through a mechanism member such as a cam ring, a guide shaft, etc., to cause at least some of or all of the zoom lens 211 to move along the optical axis. The lens controller 220 drives at least one of the lens driver 212 or the lens driver 213 according to lens control commands from the imaging unit 102 to cause at least one of the focus lens 210 or the zoom lens 211 to move along the optical axis through the mechanism member to perform at least one of a zoom operation or a focus operation. The lens control commands are, for example, zoom control commands and focus control commands. The mechanism member may include at least one of a gear or a cam.

The lens unit 200 further includes a storage device 222. The storage device 222 stores control values of the focus lens 210 and the zoom lens 211 moved by the lens driver 212 and the lens driver 213. The storage device 222 may include at least one of SRAM, DRAM, EPROM, EEPROM, or a USB storage drive.

In the above camera device 100, the lens controller 220 may control the current provided to the electric motor 216 to control the speed of the focus lens 210. When the electric motor 216 includes the DC motor, the ironless motor, or the ultrasonic motor, and after the current is stopped to be provided to the electric motor 216, the focus lens 210 may not stop instantly but may stop after a certain movement. Therefore, after the current is stopped to be provided to the electric motor 216, a distance that the focus lens 210 moves according to a predetermined speed before the focus lens 210 stops may be detected through a simulation or experiment in advance. In addition, in connection with the distance, the lens unit 220 should stop providing the current to the electric motor 216 before the focus lens 210 reaches a target position. However, the distance may change as the environment where the camera device 100 is located changes or an attitude of the camera device 100 changes. That is, from a state that the focus lens 210 moves at the predetermined speed to a state that the focus lens 210 stops, the distance that the focus lens 210 moves may change. Therefore, if the lens controller 220 wants to control the focus lens 210 to move and stop at the target position through the speed, the focus lens 210 may not be able to stop steadily.

Therefore, according to embodiments of the present disclosure, no matter what the environment or the attitude of the camera device 100 is, the lens controller 220 may cause the focus lens 210 to stop at the target position more accurately.

The lens controller 220 includes an acquisition unit 224, a determination unit 226 and a speed controller 230. The speed controller 230 may perform speed control to cause the speed of the focus lens 210 to reach a target speed. The speed controller 230 may control the current provided to the electric motor 216 according to a difference between a speed value of the focus lens 210 and a target value indicating the target speed of the focus lens 210 to perform the speed control of the target speed. The speed controller 230 may use a PID control to control the current provided to the electric motor 216 according to the difference between the speed value of the focus lens 210 and the target value indicating the target speed of the focus lens 210 to perform the speed control of the target speed.

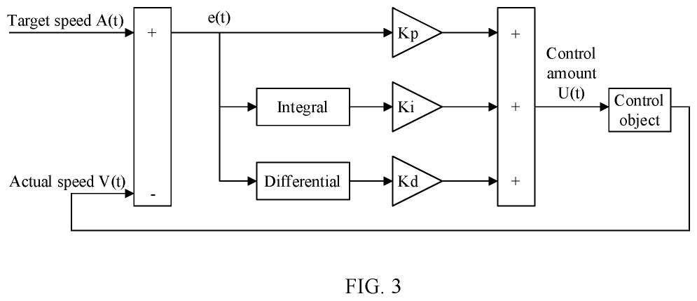

FIG. 3 is a schematic block diagram showing using the speed controller 230 to perform the PID control according to some embodiments of the present disclosure. The speed controller 230 derives a difference e(t) between a predetermined target speed A(t) and an actual speed V(t). The speed controller 230 derives a control amount U(t) that is used to control the electric motor 216 according to a value obtained by multiplying the difference e(t) by a proportional gain Kp, a value obtained by multiplying the integral value of the difference e(t) by a proportional gain Ki, and a differential value of the difference e(t). The speed controller 230 may obtain the rotation speed of the electric motor 216 detected by the encoder 218 as the value of the actual speed V(t).

Even though the target speed is the same, if the environment where the camera device 100 is located or the attitude of the camera device 100 changes, a load applied to the drive mechanism of the focus lens 210 may change. Thus, the current value of the current provided to the electric motor 216 may change. Therefore, when the speed of the focus lens 210 is controlled to be the target speed, that is, a first target speed, before the focus lens 210 is about to stop, the acquisition unit 224 may obtain a first current value of the current provided to the electric motor 216. That is, during performing the speed control of the first target speed, the acquisition unit 224 may obtain the first current value of the current provided to the electric motor 216. The speed controller 230 may control when to stop providing the current to the electric motor 216 according to the first current value, such that the focus lens 210 may stop at a first position (also referred to as a “first stop position”) when the speed control of the first target speed is performed.

For example, when the camera device 100 is in an attitude status in which the optical axis is horizontal, the current value provided to the electric motor 216 when the focus lens 210 moves at the first target speed may be set as the threshold. Moreover, the distance that the focus lens 210 moves after the current is stopped to be provided to the electric motor 216 may be set as a first distance. Under this situation, the speed controller 230 should stop providing the current to the electric motor 216 at a position that is the first distance before the first position where the focus lens 210 stops. The speed controller 230 may calculate a first providing time from a start of providing the current to the electric motor 216 until a stop of providing the current. After the first providing time from the start of providing the current to the electric motor 216, the speed controller 230 may stop providing the current to the electric motor 216.

The speed controller 230 may also calculate a first pulse number that should be recorded by the encoder 218 from the start of providing the current to the electric motor 216 until the stop of providing the current. Then, if a pulse number recorded by the encoder 218 reaches the first pulse number after the start of providing the current to the electric motor 216, the speed controller 230 may stop providing the current to the electric motor 216.

If the camera device 100 is in an attitude status in which the optical axis is not horizontal, the movement distance of the focus lens 210 after the current is stopped to be provided to the electric motor 216 may change. Therefore, if the speed controller 230 stops providing the current to the electric motor 216 according to the first providing time or at the moment of the first pulse number calculated using the first distance as a reference, the position where the focus lens 210 stops may deviate from the first position. Thus, the speed controller 230 should adjust the first distance, the first providing time, or the first pulse number according to the first current value to cause the focus lens 210 to stop at the first position.

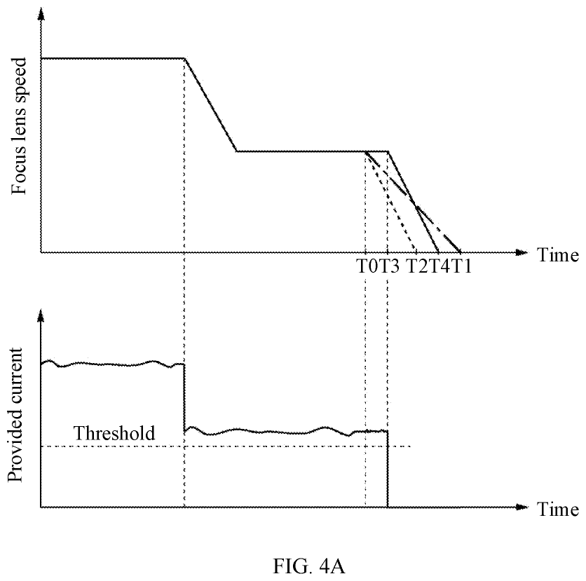

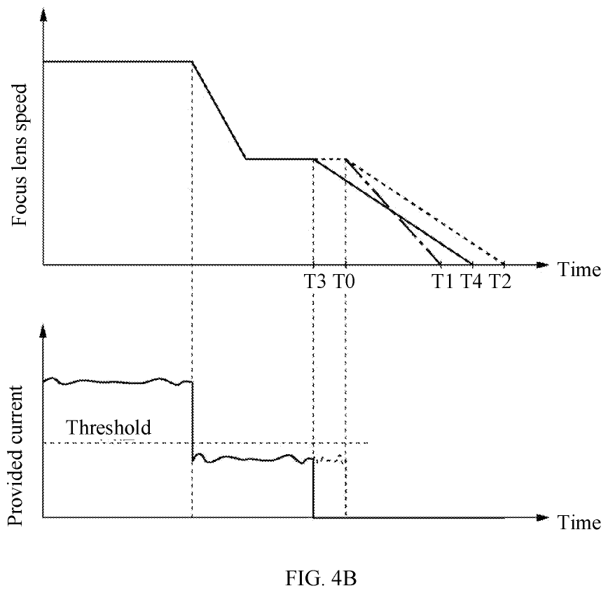

As shown in FIG. 4A, when the first current value and the threshold are equal, if the current is stopped to be provided to the electric motor 216 at moment T0, the focus lens 210 stops at moment T1. However, assume that the load applied to the drive mechanism of the focus lens 210 is relatively large, then when the first current value is greater than the threshold, the distance to the position where the focus lens 210 stops is shortened, and the focus lens 210 stops at moment T2. Therefore, when the first current value is greater than the threshold, the speed controller 230 may cause the moment of stopping providing the current to the electric motor 216 to be delayed relative to moment T0 corresponding to the threshold by a time period corresponding to a first difference value between the first current value and the threshold. The speed controller stops providing the current to the electric motor 216 at moment T3. Thus, the focus lens 210 stops at moment T4. As such, the speed controller 230 may cause the focus lens 210 to stop at the first position by adjusting the moment of stopping providing the current to the electric motor 216 according to the first current value.

As shown in FIG. 4B, when the first current value and the threshold are the same, if the speed controller 230 stops providing the current to the electric motor 216 at moment T0, the focus lens 210 stops at moment T1. However, when the first current value is smaller than the threshold, assume that the load applied to the drive mechanism of the focus lens 210 is relatively small. Therefore, when the first current value is smaller than the threshold, the distance to the position where the focus lens 210 stops may be increased, and the focus lens 210 may stop at moment T2. Therefore, when the first current value is smaller than the threshold, the speed controller 230 can cause the moment of stopping providing the current to the electric motor 216 to be earlier than moment T0 of the threshold by a time period corresponding to a first difference value between the first current value and the threshold. At moment T3, the speed controller 230 stops providing the current to the electric motor 216. Thus, the focus lens 210 stops at moment T4. As such, the speed controller 230 may cause the focus lens 210 to stop at the first position by adjusting the moment of stopping providing the current to the electric motor 216 according to the first current value.

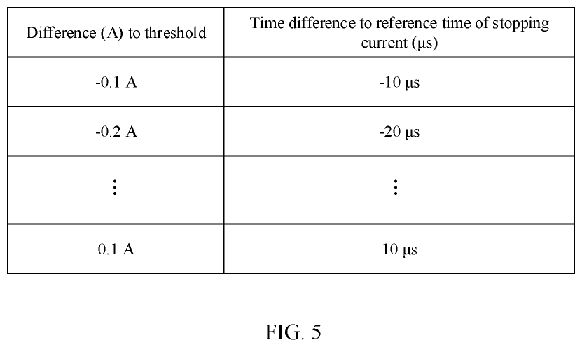

The storage device 222 may store information indicating a correspondence between a difference (A) between a reference current value and the threshold value and a time difference (μs) shown in FIG. 5. The time difference is a time difference to a reference time when the current is stopped. The speed controller 230 may control the moment of stopping providing the current to the electric motor 216 according to the information of the correspondence shown in FIG. 5 and the difference (A). The moment of stopping providing the current is also referred to as a “stop moment.”

For example, to cause the focus lens 210 to stop at the target position, the pulse number that should be recorded by the encoder 218 may be set to a pulse number N1. When the camera device 100 has a reference attitude, the pulse number counted from the stop of providing the current of the first current value (threshold) to the electric motor 216 until the focus lens 210 stops may be set to s1. Under this situation, the speed controller 230 may stop providing the current to the electric motor 216 at the moment when the encoder 218 only counts to a pulse number (N1−s1). On another hand, if the camera device 100 is not at the reference attitude, the difference between the current value of the current provided to the electric motor 216 when the focus lens 210 moves at the first target speed and the threshold may be set to ΔI. A time difference (a pulse number) corresponding to ΔI may be set to Δs. Under this situation, the speed controller 230 may stop providing the current to the electric motor 216 at a moment when the encoder 218 only counts to a pulse number of (N1−s1+Δs).

The camera device 100 may perform contrast automatic focus (AF). The camera controller 110 includes a focus controller 112. The focus controller 112 may obtain contrast values of a plurality of images captured by the imaging unit 102 when performing the contrast AF to determine a peak of the contrast value. The focus controller 112 may inform the lens controller 220 that the peak of the contrast value has been determined.

When the speed controller 230 is used to perform the speed control of the focus lens 210, the determination unit 226 may determine the target position of the focus lens 210 according to the contrast values of the plurality of images captured by the camera device 100. The determination unit 226 may determine the target position of the focus lens 210 with the contrast value as the peak value according to the plurality of images captured by the camera device 100. In response to the notice that the peak value of the contrast values has been detected, received from the focus controller 112, the determination unit 226 may determine the target position of the focus lens 210 according to the position of the focus lens 210 at the moment. Then, the speed controller 230 may calculate the pulse number that should be counted by the encoder 218 when the focus lens 210 stops before the target position according to the target position of the focus lens 210 and the current position of the focus lens 210. The speed controller 230 may use the PID control to perform the speed control to cause the acquisition unit 224 to obtain the current value of the current provided to the electric motor 216 when the focus lens 210 moves at the first target speed. The speed controller 230 may determine a time difference that needs to be adjusted according to the current value and the information indicating the correspondence between the difference between the current value and the threshold and the time difference shown in FIG. 5. Then, the speed controller 230 may control the moment of stopping providing the current to the electric motor 216 in connection with the time difference.

During detecting the peak value of the contrast value, the speed of the focus lens 210 may be fixed, but may also be a second target speed that is faster than the first target speed when the focus lens 210 is about to stop. Therefore, the determination unit 226 may determine a second position (also referred to as a “second stop position”) of the focus lens 210 as a target according to the contrast values of the plurality of images. The plurality of images may be the images captured by the camera device 100 when the speed controller 230 performs the speed control to cause the focus lens 210 to move along a first direction at the second target speed, which is faster than the first target speed. Then, to cause the focus lens 210 to stop at the second position determined by the determination unit 226, the speed controller 230 may perform the speed control to cause the speed of the focus lens 230 that moves along the first direction to reach the first target speed.

When the speed controller 230 performs the speed control to cause the speed of the focus lens 210 that moves along the first direction to reach the first target speed, the acquisition unit 224 may obtain the first current value. If the position of the focus lens 210, which is in a focus state, that is, the second position, is determined, the speed controller 230 may cause the focus lens 210 to stop temporarily at a position with a predetermined distance to the second position. Then, the speed controller 230 may cause the focus lens 210 to move along an opposite direction to cause the focus lens 210 to stop at the second position. In other words, when the peak value of the contrast value is detected, and the position of the focus lens 210, which is in the focus state, is determined, a first position that is suitable for the focus lens 210 to stop temporarily may be determined. After the peak value of the contrast value is detected, to cause the focus lens 210 to stop temporarily, the speed controller 230 may control the moment of stopping providing the current to the electric motor 216 according to the first current value. Thus, after the speed controller 230 performs the speed control to cause the speed of the focus lens 210 that moves along the first direction to reach the first target speed, the focus lens 210 may stop at the first position, which is determined according to the second position.

Further, the speed controller 230 may perform the speed control to cause the focus lens 210 to move along the second direction at the first target speed after the focus lens 210 is caused to stop at the first position. the speed controller 230 may also perform the speed control to cause the focus lens 210 to move along the second direction at the second target speed after the focus lens 210 is caused to stop at the first position. Then, the focus lens 210 may be caused to move along the second direction at the first target speed. When the speed controller 230 performs the speed control to cause the speed of the focus lens 210, which moves along the second direction, to reach the first target speed, the acquisition unit 224 may obtain a second current value of the current provided to the electric motor 216. The speed controller 230 may control the moment of stopping providing the current to the electric motor 216 according to the second current value to cause the focus lens 210, which moves along the second direction at the first target speed, to stop at the second position. The speed controller 230 may determine the time difference according to the information indicating the correspondence between the current value difference and the time difference shown in FIG. 5. The speed controller 230 may further control the moment of stopping providing the current to the electric motor 216 according to the time difference to cause the focus lens 210, which moves along the second direction at the first target speed, to stop at the second position.

The storage device 222 may also store information indicating a correspondence between the difference between the current value and the threshold and the time difference according to the moving directions of the focus lens 210.

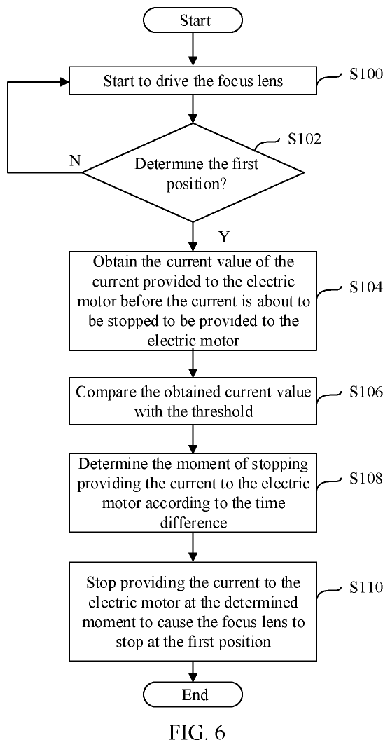

FIG. 6 is a schematic flowchart showing controlling the focus lens 210 to move according to some embodiments of the present disclosure. The speed controller 230 starts to drive the focus lens 210 (S100). To perform the contrast AF and cause the focus lens 210 to move along the first direction, the speed controller 230 may start to drive the focus lens 210. To cause the focus lens 210 to move at the second target speed, the speed controller 230 may use the PID control to control the current provided to the electric motor 216. When the speed control is performed to cause the focus lens 210 to move at the second target speed, the focus controller 112 may determine the target position, i.e., the second position, of the focus lens 210, at which the contrast value is the peak value, according to the plurality of images captured by the camera device 100. The determination unit 226 determines the first position (S102). The first position is in the first direction and has the predetermined distance to the second position noticed by the focus controller 112.

To stop the focus lens 210, the speed controller 230 may cause the speed of the focus lens 210 to be the first target speed through the speed control. When the speed control of the first target speed is performed, the acquisition unit 224 obtains the current value of the current provided to the electric motor 216 before the current is about to be stopped to be provided to the electric motor 216 (S104). The speed controller 230 compares the obtained current value with the threshold (S106). The speed controller 230 determines the time difference corresponding to the difference between the current value and the threshold according to the information indicating the correspondence between the difference of the current values and the time difference and determines the moment of stopping providing the current to the electric motor 216 according to the time difference (S108). The speed controller 230 may also use the moment of using the threshold current to control the speed of the focus lens 210 to be the target speed as a reference. The moment of stopping providing the current to the electric motor 216 may be adjusted according to the time difference determined. Thus, the moment of stopping providing the current to the electric motor 216 may be determined. The speed controller 230 stops providing the current to the electric motor 216 at the determined moment to cause the focus lens 210 to stop at the first position (S110). The moment of stopping providing the current to cause the focus lens 210 to stop at the first position is also referred to as a “first stop moment.”

Then, the speed controller 230 may cause the focus lens 210 to move along the second direction and cause the focus lens 210 to stop at the second position. Similar to the situation of causing the focus lens 210 to move along the first direction, when the speed controller 230 performs the speed control to cause the speed of the focus lens 210 to reach the first target speed, the acquisition unit 224 may obtain the current value of the current provided to the electric motor 216. Then, the speed controller 230 may adjust the moment of stopping providing the current to the electric motor 216 according to the comparison of the obtained current value and the threshold to cause the focus lens 210 to stop at the second position. The moment of stopping providing the current to cause the focus lens 210 to stop at the second position is also referred to as a “second stop moment.”

As described above, according to the camera device 100 of embodiments of the present disclosure, when the speed control of the target speed is performed, and the current value of the current provided to the electric motor 216 is greater than the threshold, the moment of stopping providing the current to the electric motor 216 may be delayed. On another hand, when the current value is smaller than the threshold, the moment of stopping providing the current to the electric motor 216 may be shifted earlier. As such, even if changes of the attitude and the application environment of the camera device 100, which cause the load of the drive mechanism of the focus lens 210 to change, occur, the focus lens 210 may be caused to stop at the target position more accurately.

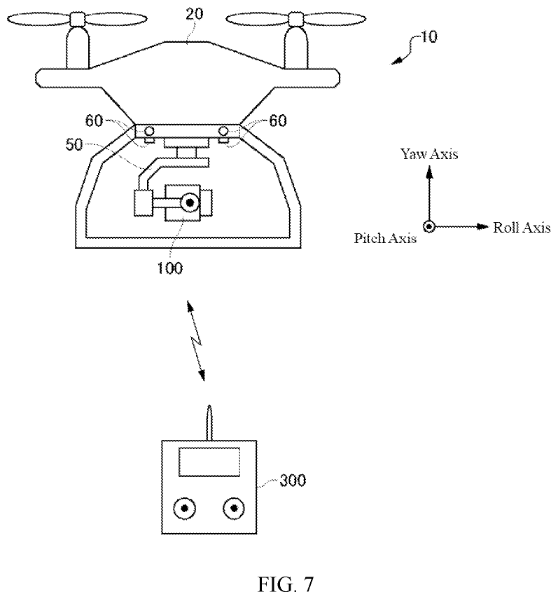

The camera device 100 may be carried by a mobile body, such as an unmanned aerial vehicle (UAV) 10, as shown in FIG. 7. The UAV 10 includes a UAV body 20, a gimbal 50, a plurality of camera devices 60, and a camera device 100. The gimbal 50 and the camera device 100 are an example of a camera system. The UAV 10 is an example of a mobile body propelled by a propeller. In some embodiments, besides the UAV, the mobile body can include an aerial body such as an airplane capable of moving in the air, a vehicle capable of moving on the ground, a ship capable of moving on the water, etc.

The UAV body 20 includes a plurality of rotors. The plurality of rotors are an example of the propeller. The UAV body 20 controls rotations of the plurality of rotors to cause the UAV 10 to fly. The UAV body 20 uses, for example, four rotors to cause the UAV 10 to fly. A number of the rotors is not limited to four. In some embodiments, the UAV 10 may also be a fixed-wing aircraft without a rotor.

The camera device 100 is an imaging camera that captures an object within a desired imaging range. The gimbal 50 can rotatably support the camera device 100. The gimbal 50 is an example of a supporting mechanism. For example, the gimbal 50 uses an actuator to rotatably support the camera device 100 on a pitch axis. The gimbal 50 uses an actuator to further support the camera device 100 rotatably by using a roll axis and a yaw axis as rotation axes. The gimbal 50 can rotate the camera device 100 around at least one of the yaw axis, the pitch axis, or the roll axis to change the attitude of the camera device 100.

The plurality of camera devices 60 are sensing cameras that sense surroundings to control the flight of the UAV 10. Two of the camera devices 60 may be arranged at a nose, i.e., the front, of the UAV 10. The other two camera devices 60 may be arranged at the bottom of the UAV 10. The two camera devices 60 at the front can be used in pair, which function as a stereo camera. The two camera devices 60 at the bottom may also be used in pair, which function as a stereo camera. The UAV 10 can generate three-dimensional space data for the surrounding of the UAV 10 based on images captured by the plurality of camera devices 60. A number of the camera devices 60 of the UAV 10 is not limited to four, and can be one. The UAV 10 may also include at least one camera device 60 at each of the nose, tail, each side, bottom, and top. An angle of view that can be set in the camera device 60 may be larger than an angle of view that can be set in the camera device 100. The camera device 60 may include a single focus lens or a fisheye lens.

The remote operation device 300 communicates with the UAV 10 to control the UAV 10 remotely. The remote operation device 300 may communicate with the UAV 10 wirelessly. The remote operation device 300 transmits to the UAV 10 instruction information indicating various commands related to the movement of the UAV 10 such as ascent, descent, acceleration, deceleration, forward, backward, rotation, etc. The instruction information includes, for example, instruction information to ascend the UAV 10. The instruction information may indicate a desired height for the UAV 10. The UAV 10 moves to a height indicated by the instruction information received from the remote operation device 300. The instruction information may include an ascending command to ascend the UAV 10. The UAV 10 ascend when receiving the ascending command. When the UAV 10 reaches an upper limit in height, even the UAV 10 receives the ascending command, the UAV 10 may be limited from further ascending.

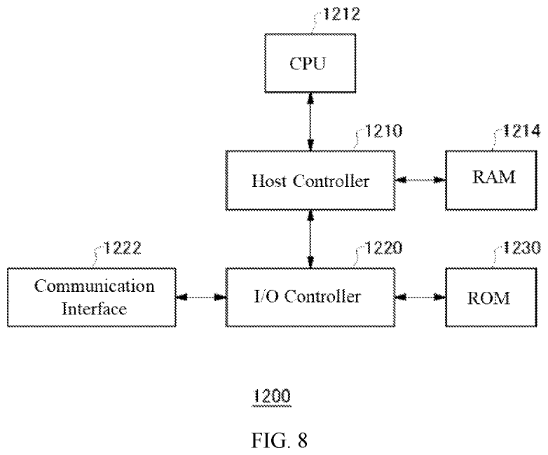

FIG. 8 shows an example of a computer 1200 that fully or partially represents the present disclosure. Programs installed on the computer 1200 can cause the computer 1200 to function as an operation associated with a device or one or more units of the device according to embodiments of the present disclosure. In some embodiments, the program can cause the computer 1200 to implement the operation or one or more units. The program may cause the computer 1200 to implement a process or a stage of the process according to embodiments of the present disclosure. The program may be executed by a CPU 1212 to cause the computer 1200, e.g., the CPU 1212, to implement a specified operation associated with some or all blocks in the flowchart and block diagram described in the present specification.

In some embodiments, the computer 1200 includes the CPU 1212 and a RAM 1214. The CPU 1212 and the RAM 1214 are connected to each other through a host controller 1210. The computer 1200 further includes a communication interface 1222, and an I/O unit. The communication interface 1222 and the I/O unit are connected to the host controller 1210 through an I/O controller 1220. The computer 1200 further includes a ROM 1230. The CPU 1212 operates according to programs stored in the ROM 1230 and the RAM 1214 to control each of the units.

The communication interface 1222 communicates with other electronic devices through networks. A hardware driver may store the programs and data used by the CPU 1212 of the computer 1200. The ROM 1230 stores a boot program executed by the computer 1200 during operation, and/or the program dependent on the hardware of the computer 1200. The program is provided through a computer-readable storage medium such as CR-ROM, a USB storage drive, or IC card, or networks. The program is installed in the RAM 1214 or the ROM 1230, which can also be used as examples of the computer-readable storage medium, and is executed by the CPU 1212. Information processing described in the program is read by the computer 1200 to cause cooperation between the program and the above-mentioned various types of hardware resources. The computer 1200 implements information operations or processes to constitute the device or method.

For example, when the computer 1200 communicates with external devices, the CPU 1212 can execute a communication program loaded in the RAM 1214 and command the communication interface 1222 to process the communication based on the processes described in the communication program. The CPU 1212 controls the communication interface 1222 to read transmitting data in a transmitting buffer provided by a storage medium such as the RAM 1214 or the USB storage drive and transmit the read transmitting data to the networks, or write data received from the networks in a receiving buffer provided by the storage medium.

The CPU 1212 can cause the RAM 1214 to read all or needed portions of files or databases stored in an external storage medium such as a USB storage drive, and perform various types of processing to the data of the RAM 1214. Then, the CPU 1212 can write the processed data back to the external storage medium.

Various types of information such as various types of programs, data, tables, and databases may be stored in the storage medium and process the information. For the data read from the RAM 1214, the CPU 1212 can perform the various types of processes described in the present disclosure, including various types of operations, information processing, condition judgment, conditional transfer, unconditional transfer, information retrieval/replacement, etc., specified by a command sequence of the program, and write the result back to the RAM 1214. In addition, the CPU 1212 can retrieve information in files, databases, etc., in the storage medium. For example, when the CPU 1212 stores a plurality of entries having attribute values of a first attribute associated with attribute values of a second attribute in the storage medium, the CPU 1212 can retrieve an attribute from the plurality of entries matching a condition specifying the attribute value of the first attribute, and read the attribute value of the second attribute stored in the entry. As such, the CPU 1212 obtains the attribute value of the second attribute associated with the first attribute that meets the predetermined condition.

The above-described programs or software modules may be stored on the computer 1200 or in the computer-readable storage medium near the computer 1200. The storage medium such as a hard disk drive or RAM provided in a server system connected to a dedicated communication network or Internet can be used as a computer-readable storage medium. Thus, the program can be provided to the computer 1200 through the networks.

The present disclosure is described above with reference to embodiments, but the technical scope of the present disclosure is not limited to the scope described in the above embodiments. For those of ordinary skill in the art, various changes or improvements can be made to the above-described embodiments, which are within the scope of the disclosure.

An execution order of various processing such as actions, sequences, processes, and stages in the devices, systems, programs, and methods shown in the claims, the specifications, and the drawings, can be any order, unless otherwise specifically indicated by “before,” “in advance,” etc., and as long as an output of a previous processing is not used in a subsequent processing. Operation procedures in the claims, the specifications, and the drawings are described using “first,” “next,” etc., for convenience. However, it does not mean that the operation procedures must be implemented in this order.

What is claimed is:

1. A control device comprising:
a processor; and
a storage device storing a program that, when executed by the processor, causes the processor to:
perform speed control to cause a speed of a lens of a camera device to reach a target speed;
during the speed control, obtain a current value of a current provided to an electric motor of the camera device configured to drive the lens;
determine a stop moment of stopping providing the current to the electric motor according to the current value; and
control to stop providing the current to the electric motor at the stop moment to cause the lens to stop at a stop position.

2. The device of claim 1, wherein the program further causes the processor to:
perform the speed control by controlling the current provided to the electric motor according to a difference between the speed of the lens and the target speed.

3. The device of claim 1, wherein the program further causes the processor to:
in response to the current value being greater than a threshold, determine the stop moment to be later than a moment corresponding to the threshold by a time period corresponding to a difference between the current value and the threshold.

4. The device of claim 1, wherein the program further causes the processor to:
in response to the current value being smaller than a threshold, determine the stop moment to be earlier than a moment corresponding to the threshold by a time period corresponding to a difference between the current value and the threshold.

5. The device of claim 1, wherein the stop position is a first stop position, the target speed is a first target speed, and the program further causes the processor to:
determine a second stop position of the lens according to contrast values of a plurality of images, the plurality of images being captured by the camera device while the lens moves along a direction at a second target speed;
perform the speed control to cause the speed of the lens in the direction to reach the first target speed;
obtain the current value while performing the speed control to cause the speed of the lens along the direction to reach the first target speed; and
after the speed of the lens along the direction reaches the first target speed, control to stop providing the current to the electric motor at the stop moment according to the current value to cause the lens to stop at the first stop position, which is determined according to the second stop position.

6. The device of claim 5, wherein the direction is a first direction, the current value is a first current value, the stop moment is a first stop moment, and the program further causes the processor to:
after the lens stops at the first stop position, control the lens to move along a second direction at the first target speed;
obtain a second current value of the current provided to the electric motor while causing the speed of the lens along the second direction to reach the first target speed;
determine a second stop moment of stopping providing the current to the electric motor according to the second current value; and
control the lens, which is moving along the second direction at the first target speed, to stop at the second stop position.

7. The device of claim 1, wherein the electric motor is configured to drive the lens through a gear or a cam.

8. A camera device comprising:
a lens;
an electric motor configured to drive the lens;
an image sensor; and
a control device including:
a processor; and
a storage device storing a program that, when executed by the processor, causes the processor to:
perform speed control to cause a speed of the lens to reach a target speed;
during the speed control, obtain a current value of a current provided to the electric motor;
determine a stop moment of stopping providing the current to the electric motor according to the current value; and
control to stop providing the current to the electric motor at the stop moment to cause the lens to stop at a stop position.

9. A mobile body comprising:
the camera device of claim 8; and
a support mechanism supporting the camera device and configured to adjust an attitude of the camera device.

10. The mobile body of claim 9, wherein the program further causes the processor to:
perform the speed control by controlling the current provided to the electric motor according to a difference between the speed of the lens and the target speed.

11. The mobile body of claim 9, wherein the program further causes the processor to:
in response to the current value being greater than a threshold, determine the stop moment to be later than a moment corresponding to the threshold by a time period corresponding to a difference between the current value and the threshold.

12. The mobile body of claim 9, wherein the program further causes the processor to:
in response to the current value being smaller than a threshold, determine the stop moment to be earlier than a moment corresponding to the threshold by a time period corresponding to a difference between the current value and the threshold.

13. The mobile body of claim 9, wherein the stop position is a first stop position, the target speed is a first target speed, and the program further causes the processor to:
determine a second stop position of the lens according to contrast values of a plurality of images, the plurality of images being captured by the camera device while the lens moves along a direction at a second target speed;
perform the speed control to cause the speed of the lens in the direction to reach the first target speed;
obtain the current value while performing the speed control to cause the speed of the lens along the direction to reach the first target speed; and
after the speed of the lens along the direction reaches the first target speed, control to stop providing the current to the electric motor at the stop moment according to the current value to cause the lens to stop at the first stop position, which is determined according to the second stop position.

14. The mobile body of claim 13, wherein the direction is a first direction, the current value is a first current value, the stop moment is a first stop moment, and the program further causes the processor to:
after the lens stops at the first stop position, control the lens to move along a second direction at the first target speed;
obtain a second current value of the current provided to the electric motor while causing the speed of the lens along the second direction to reach the first target speed;
determine a second stop moment of stopping providing the current to the electric motor according to the second current value; and
control the lens, which is moving along the second direction at the first target speed, to stop at the second stop position.

15. A control method comprising:
performing speed control to cause a speed of a lens of a camera device to reach a target speed;
during the speed control, obtaining a current value of a current provided to an electric motor of the camera device configured to drive the lens;
determining a stop moment of stopping providing the current to the electric motor according to the current value; and
controlling to stop providing the current to the electric motor at the stop moment to cause the lens to stop at a stop position.

16. The method of claim 15, further comprising:
performing the speed control by controlling the current provided to the electric motor according to a difference between the speed of the lens and the target speed.

17. The method of claim 15, further comprising:
in response to the current value being greater than a threshold, determining the stop moment to be later than a moment corresponding to the threshold by a time period corresponding to a difference between the current value and the threshold.

18. The method of claim 15, further comprising:
in response to the current value being smaller than a threshold, determining the stop moment to be earlier than a moment corresponding to the threshold by a time period corresponding to a difference between the current value and the threshold.

19. The method of claim 15, further comprising, the position being a first position, and the target speed being a first target speed:
determining a second stop position of the lens according to contrast values of a plurality of images, the plurality of images being captured by the camera device while the lens moves along a direction at a second target speed;
performing the speed control to cause the speed of the lens in the direction to reach the first target speed;
obtaining the current value while performing the speed control to cause the speed of the lens along the direction to reach the first target speed; and
after the speed of the lens along the direction reaches the first target speed, controlling to stop providing the current to the electric motor at the stop moment according to the current value to cause the lens to stop at the first stop position, which is determined according to the second stop position.

20. The method of claim 19, further comprising, the direction being a first direction, the current value being a first current value, and the stop moment being a first stop moment:
after the lens stops at the first stop position, controlling the lens to move along a second direction at the first target speed;
obtaining a second current value of the current provided to the electric motor while causing the speed of the lens along the second direction to reach the first target speed; and
determining a second stop moment of stopping providing the current to the electric motor according to the second current value; and
controlling the lens, which is moving along the second direction at the first target speed, to stop at the second stop position.
